(19) United States
(12) Patent Application Publication
(10) Pub. No.: US 2026/0194202 A1
(43) Pub. Date: Jul. 9, 2026

(54) CONVERTIBLE VEHICLE LAMP ASSEMBLIES

(71) Applicant: FORD GLOBAL TECHNOLOGIES, LLC, Dearborn, MI (US)

(72) Inventors: Joel Jaszcz, Allen Park, MI (US); Scott Aaron Ford, Plymouth, MI (US)

(21) Appl. No.: 19/010,650

(22) Filed: Jan. 6, 2025

(51) Int. Cl. F21S 43/00; F21S 43/14; F21S 43/15; F21S 43/20; F21V 23/00; F21W 103/10; F21Y 103/10; F21Y 115/10

(52) U.S. Cl. CPC F21S 43/601; F21S 43/14; F21S 43/15; F21S 43/265; F21V 23/005; F21W 2103/10; F21Y 2103/10; F21Y 2115/10

(57) ABSTRACT

A device may include a housing. A device may include a light bar arranged within the housing and configured to emit light. A device may include a bezel or a light blocking component arranged adjacent to the light bar and configured to block at least a portion of the light emitted from the light bar to provide more than one light section within the adaptable lamp assembly.

### TECHNICAL FIELD

This disclosure relates generally to motor vehicles, and more particularly to convertible vehicle lamp assemblies.

### BACKGROUND

Some vehicles, such as wide-body pickup trucks, have identification lamps to alert other drivers of their presence and dimensions. These identification lamps have distinctive lighting configurations that signal the size of the vehicle.

### SUMMARY

In some aspects, the techniques described herein relate to a vehicle exterior lighting system, including: an adaptable lamp assembly including: a housing, a light bar arranged within the housing and configured to emit light, and a bezel or a light blocking component arranged adjacent to the light bar and configured to block at least a portion of the light emitted from the light bar to provide more than one light section within the adaptable lamp assembly.

In some aspects, the techniques described herein relate to a vehicle exterior lighting system, wherein the bezel includes a plurality of openings to allow the light from the light bar to be transmitted through the bezel.

In some aspects, the techniques described herein relate to a vehicle exterior lighting system, wherein the plurality of openings includes a first opening, a second opening, and a third opening, and wherein a first portion of the light transmitted through the first opening provides a first light section of the adaptable lamp assembly, a second portion of the light transmitted through the second opening provides a second light section of the adaptable lamp assembly, and a third portion of the light transmitted through the third opening provides a third light section of the adaptable lamp assembly.

In some aspects, the techniques described herein relate to a vehicle exterior lighting system, further including a first lens component disposed outwardly of the bezel, wherein the bezel is opaque and the first lens component is transparent.

In some aspects, the techniques described herein relate to a vehicle exterior lighting system, wherein the bezel is a first bezel that provides a first type of identification lamp of the adaptable lamp assembly, and further including a second bezel configured to replace the first bezel to provide a second type of identification lamp of the adaptable lamp assembly.

In some aspects, the techniques described herein relate to a vehicle exterior lighting system, wherein an elongated opening of the second bezel is aligned with the light bar.

In some aspects, the techniques described herein relate to a vehicle exterior lighting system, further including a second lens component disposed outwardly of the second bezel.

In some aspects, the techniques described herein relate to a vehicle exterior lighting system, wherein the second bezel is opaque and the second lens component is transparent.

In some aspects, the techniques described herein relate to a vehicle exterior lighting system, wherein the light blocking component is a first light blocking component, and further including a second light blocking component arranged adjacent to the light bar and configured to block at least another portion of the light emitted from the light bar, the first light blocking component and the second light blocking component each include a pocket configured to receive and cover a portion of the light bar.

In some aspects, the techniques described herein relate to a vehicle exterior lighting system, wherein the first light blocking component and the second light blocking component are spaced apart to divide the light bar into a first light section, a second light section, and a third light section.

In some aspects, the techniques described herein relate to a vehicle exterior lighting system, further including an outer bezel attached to the housing over the first light blocking component and the second light blocking component, and wherein the first light blocking component and the second light blocking component are positioned between the housing and the outer bezel.

In some aspects, the techniques described herein relate to a vehicle exterior lighting system, further including a lens component disposed outwardly of the outer bezel.

In some aspects, the techniques described herein relate to a vehicle exterior lighting system, wherein the first light blocking component, the second light blocking component, and the outer bezel are opaque, and the lens component is transparent.

In some aspects, the techniques described herein relate to a vehicle exterior lighting system, wherein the adaptable lamp assembly is a rear identification lamp.

In some aspects, the techniques described herein relate to a vehicle exterior lighting system, wherein the bezel or the light blocking component is a removable component of the adaptable lamp assembly to convert the rear identification lamp into a center high-mounted stop lamp.

In some aspects, the techniques described herein relate to a vehicle lamp assembly method, including: arranging a bezel or a light blocking component adjacent to a light bar within a housing of an adaptable lamp assembly to configure the adaptable lamp assembly as a first type of identification lamp for a motor vehicle.

In some aspects, the techniques described herein relate to a vehicle lamp assembly method, wherein the bezel includes a first opening, a second opening, and a third opening, and wherein the first type of identification lamp transmits light through the first opening, the second opening, and the third opening to provide a first light section, a second light section, and third light section.

In some aspects, the techniques described herein relate to a vehicle lamp assembly method, wherein the light blocking component is a first light blocking component, and further including a second light blocking component configured to block at least a portion of the light emitted from the light bar.

In some aspects, the techniques described herein relate to a vehicle lamp assembly method, wherein the first type of identification lamp is a rear identification lamp.

In some aspects, the techniques described herein relate to a vehicle lamp assembly method, further including removing the bezel or the light blocking component to convert the rear identification lamp to a center high-mounted stop lamp.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle equipped with a lamp assembly.

FIG. 2 is an exploded view of the lamp assembly of FIG. 1.

FIG. 3 is a perspective view of the lamp assembly of FIG. 2.

FIG. 4 is an exploded view of another exemplary lamp assembly.

FIG. 5 is an exploded view of yet another exemplary lamp assembly.

### DETAILED DESCRIPTION

This disclosure details convertible lamp assemblies for vehicles. For example, a rear lamp assembly may be adaptable to convert a first type of identification lamp (e.g., a center high-mounted stop lamp (CHMSL) assembly) into a second type of identification lamp (e.g., a rear identification (read ID) lamp). An exemplary lamp assembly may include at least one bezel or at least one light blocking component that is configured to block at least a portion of the light emitted from a light bar in order to provide the desired adaptability. These and other features are discussed in greater detail in the following paragraphs of this detailed description.

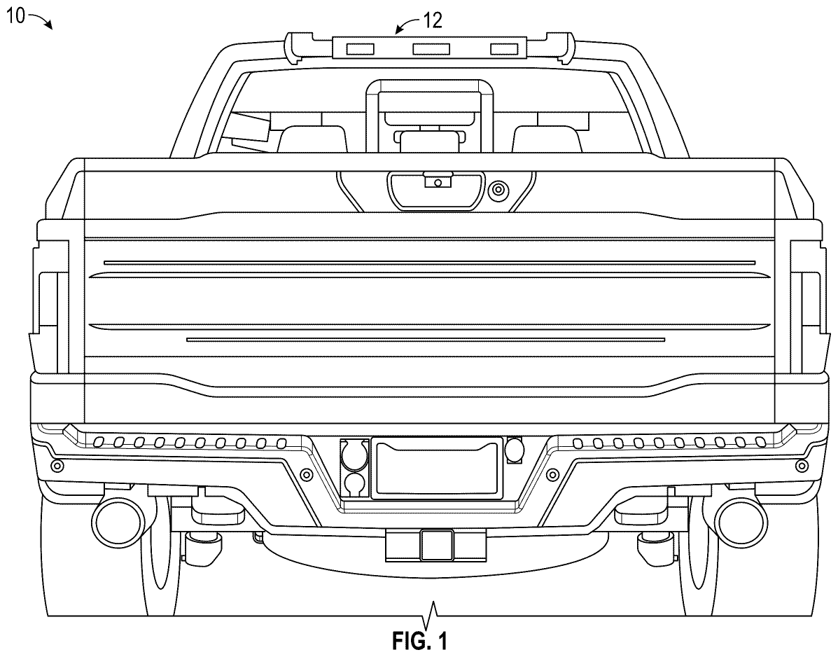

FIG. 1 schematically illustrates a vehicle 10 that includes a lamp assembly 12, which in this embodiment is a rear lamp assembly. However, as would be appreciated by persons of ordinary skill in the art, the teachings of this disclosure could extend to any vehicle lamp assembly.

In an embodiment, the vehicle 10 is a pickup truck that is classified as a wide-body vehicle (i.e., a vehicle having a width of 80 inches or more). Accordingly, the lamp assembly 12 is a rear identification (rear ID) lamp rather than a center high-mounted stop lamp (CHMSL). The lamp assembly 12 includes three distinct red light sections aligned horizontally at the rear of the vehicle 10. In contrast to a CHMSL, which activates during braking to signal vehicle deceleration, for example, the lamp assembly 12 remains illuminated when the vehicle's lights are on to indicate the vehicle's width and presence to other drivers and thereby improve the visibility of the vehicle 10 at night or in adverse weather conditions. Although the lamp assembly 12 is described in relation to a wide-body pickup truck, the teachings of this disclosure could apply to other vehicles, such as a tractor, for example.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

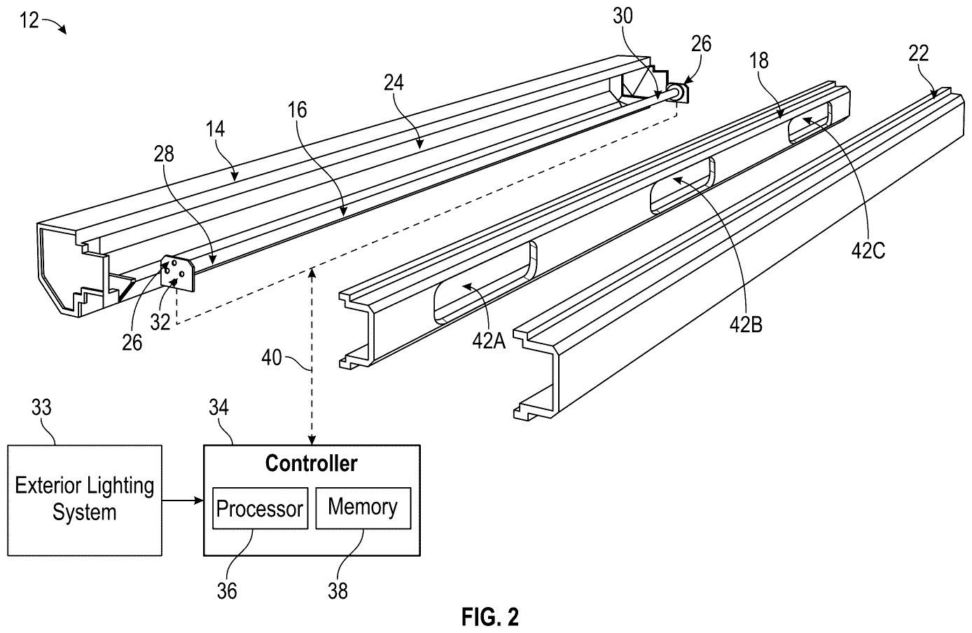

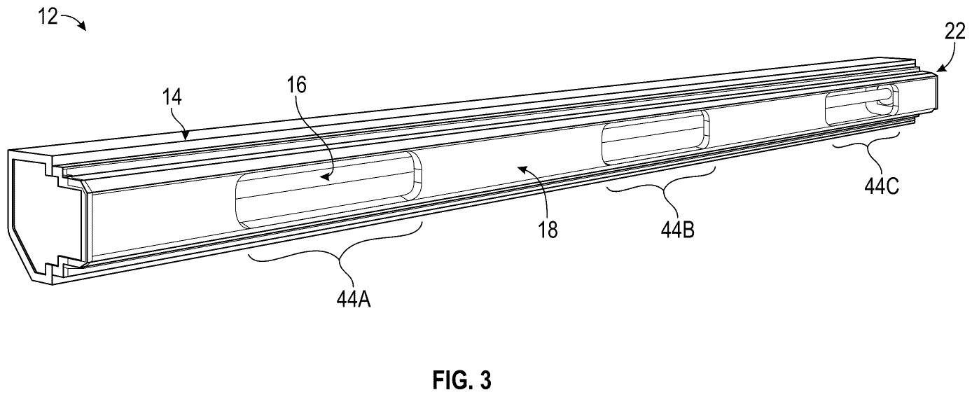

FIGS. 2 and 3 further illustrate the lamp assembly 12 of the vehicle 10 of FIG. 1. The lamp assembly 12 may include a housing 14, a light bar 16, a bezel 18, and a lens component 22. The housing 14 may be designed to accommodate the light bar 16. In an embodiment, the housing 14 includes a recessed area 24 that is sized and shaped to securely receive and support the light bar 16. The housing 14 may be made of an opaque material to block light transfer from the light bar 16. This ensures that light emitted by the light bar 16 is transmitted in an intended direction (i.e., rearward of the vehicle 10).

The light bar 16 may be arranged within the housing 14 and is configured to emit light in a desirable color (e.g., red). A printed circuit board (PCB) 26 may be connected to each of a first end portion 28 and an opposite second end portion 30 of the light bar 16. The PCB 26 may support a plurality of light emitting diodes (LEDs) 32 that are each configured to emit the light into the light bar 16.

The lamp assembly 12 may be part of an exterior lighting system 33 of the vehicle 10. The exterior lighting system 33 may include various additional lamp assemblies positioned on the vehicle 10 to provide illumination and visibility enhancement. In an embodiment, these additional lamp assemblies can include headlights and taillights, which are typically activated in low light conditions, either manually or automatically.

A controller 34 may be operably connected to the exterior lighting system 33. Although schematically illustrated as a single controller, the controller 34 may be part of a vehicle control system that includes a plurality of additional control modules for interfacing with and commanding operations of each PCB 26. In an embodiment, the controller 34 is part of a body control module (BCM) of the vehicle 10. However, other configurations are also contemplated within the scope of this disclosure.

The controller 34 may include both hardware and software and may be programmed with executable instructions for interfacing with and commanding operation of various components of the PCB 26 as part of a strategy for operating the LEDs 32. The controller 34 may include a processor 36 and non-transitory memory 38 for executing various control strategies and modes associated with each PCB 26. The processor 36 may be a custom made or a commercially available processor, a central processing unit (CPU), or generally any device for executing software instructions. The memory 38 can include any one or combination of volatile memory elements and/or nonvolatile memory elements. The processor 36 may be operably coupled to the memory 38 and may be configured to execute one or more programs stored in the memory based on various inputs received from the exterior lighting system 33.

Each PCB 26 may be operably connected to the controller 34 over a communication bus 40. In an embodiment, the communication bus 40 is a wired communication bus such as a controller area network (CAN) bus or a local interconnect network (LIN) bus, for example. In another embodiment, the communication bus 40 is a wireless communication bus such as that provided by Wi-Fi, Bluetooth®, Ultra-Wide Band (UWB), etc.

The controller 34 may be programmed to operate each PCB 26 and the LEDs 32 based on a signal indicating the activation of the exterior lighting system 33. In an embodiment, the controller 34 commands each PCB 26 to power its respective LEDs 32 when the exterior lighting system 33 has been activated. When activated, the LEDs 32 emit light, which is diffused and projected outwardly by the light bar 16 to provide exterior illumination. In a further embodiment, when the controller 34 detects a signal indicating that the exterior lighting system 33 has been deactivated, the controller 34 commands each PCB 26 to deactivate the LEDs 32. The controller 34 can thus ensure that the LEDs 32 and the light bar 16 respond automatically to status changes of the exterior lighting system 33.

The bezel 18 may be attached to the housing 14 to at least partially enclose the light bar 16 within the housing 14. The bezel 18 could be attached to the housing 14 via fasteners, clips, an adhesive, or any combinations thereof. The bezel 18 may be made of an opaque material that can block light transfer from the light bar 16.

The bezel 18 may include a plurality of openings 42 to allow light from the light bar 16 to be transmitted therethrough. Each of the openings 42 may be aligned with the light bar 16 and may establish an area where the light bar 16 is uncovered by the opaque material of the bezel 18. Light transmitted by the light bar 16 may pass through each of the openings 42 to configure the lamp assembly 12 to function as a rear ID lamp.

In an embodiment, the bezel 18 includes a first opening 42A, a second opening 42B, and a third opening 42C. As shown in FIG. 3, the first opening 42A provides a first light section 44A for transmitting a first portion of light from the light bar 16, the second opening 42B provides a second light section 44B for transmitting a second portion of light from the light bar 16, and the third opening 42C provides a second light section 44C for transmitting a third portion of light from the light bar 16. The opaque portions of the bezel 18, which flank each opening 42A-42C, continue to block light from the light bar 16 so that light can only be directed through the openings 42 of the bezel 18.

The size and placement of the light sections 44 can be adjusted by changing the spacing between the openings 42. In an embodiment, the center-to-center spacing between each of the light sections 44 is at least 6 inches (or 15.24 centimeters)—that is, the distance from the center of one light section 44 to the center of an adjacent light section 44 measures at least 6 inches along the horizontal axis.

The lens component 22 may be disposed outwardly of the bezel 18 and may at least partially enclose the light bar 16 and the bezel 18 within the housing 14. The lens component 22 may be made of a transparent material to allow light that has passed through the openings 42 from the light bar 16 to pass therethrough. The lens component 22 also protects the internal components of the lamp assembly 12, such as the light bar 16, the PCB 26, and the LEDs 32, from external moisture and debris (e.g., dust, dirt, etc.).

In an embodiment, the bezel 18 and the lens component 22 may be formed together as a single component using a two-shot molding technique. As used herein, a “two-shot molding technique” is a manufacturing process that allows two different materials to be molded together into a single integrated component. The opaque material for the bezel 18 may be injected into a first shot mold cavity to create the structure of the bezel 18. The transparent material for the lens component 22 may be injected into a second shot mold cavity to create the structure of the lens component 22. The bezel 18 and the lens component 22 may then be bonded together at their interfaces to form a single component with both an opaque region (i.e. the bezel 18) and a transparent region (i.e., the outer lens component 22). The openings 42 of the bezel 18 can be formed either during or after the molding process.

In this disclosure, like reference numerals designate like elements where appropriate and reference numerals with the addition of one-hundred or multiples thereof designate modified elements that are understood to incorporate the same features and benefits of the corresponding elements.

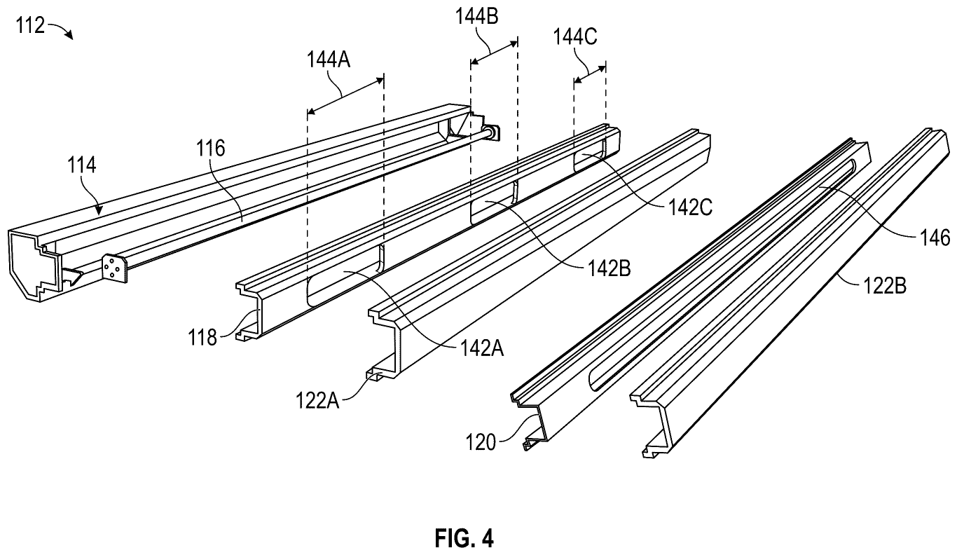

FIG. 4 illustrates another exemplary lamp assembly 112. The lamp assembly 112 is similar to the lamp assembly 12 discussed above. However, in this embodiment, the lamp assembly 112 could include a first bezel 118 or a second bezel 120.

The first bezel 118 may be attached to a housing 114 of the lamp assembly 112 to at least partially enclose a light bar 116 within the housing 114. Light transmitted by the light bar 116 may pass through a plurality of openings 142 formed in the first bezel 118 to provide a lamp assembly 12 that functions as a rear ID lamp. The first bezel 118 may be made of an opaque material that otherwise blocks light from the light bar 116 that is not transmitted through the openings 142. Like the bezel 18 of FIG. 3, light transmitted through a first opening 142A provides a first light section 144A, light transmitted through a second opening 142B provides a second light section 144B, and light transmitted through a third opening 142C provides a third light section 144C of the lamp assembly 112.

A first lens component 122A may be disposed outwardly of the first bezel 118 and may at least partially enclose the light bar 116 within the housing 114. Light that is transmitted through the openings 142 is thereafter transmitted through the first lens component 122A, which may be made of a transparent material.

Alternatively, the second bezel 120 may be attached to the housing 114 to at least partially enclose a light bar 116 within the housing 114. The second bezel 120 may be made of an opaque material and may include an elongated opening 146. The elongated opening 146 may be aligned with the light bar 116 and may establish an area where the light bar 116 is uncovered by the opaque material of the second bezel 120.

A second lens component 122B may be disposed outwardly of the second bezel 120. The second lens component 122B may be made of a transparent material that allows light transmitted through the second bezel 120 to also be transmitted through the second lens component 122B. The second bezel 120 may be used to convert the lamp assembly 112 into a CHSML.

In an embodiment, the second bezel 120 and the second lens component 122B may be formed together as a single integrated component using the two-shot technique discussed above.

In an alternative embodiment, the second bezel 120 can be used without the first bezel 118. In such an embodiment, the second bezel 120 may be attached to the housing 114 in the same manner as the first bezel 118. The elongated opening 146 allows more light from the light bar 116 to be transmitted through it as a single light section such that the lamp assembly 112 can function as a CHMSL. This configuration may be useful for non-wide-body vehicle applications, for example. Accordingly, the lamp assembly 112 is adaptable to meet different functional requirements with the first bezel 118 and/or the second bezel 120.

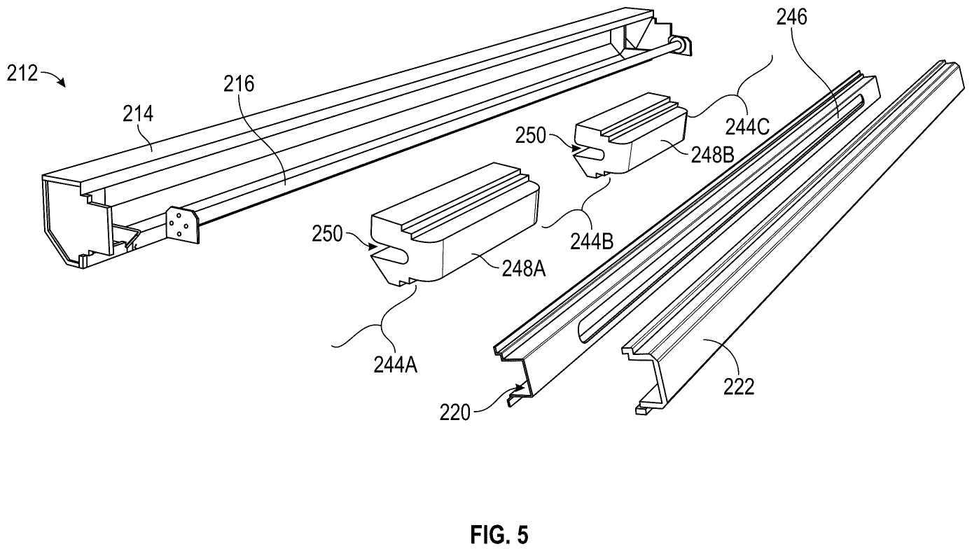

FIG. 5 illustrates yet another exemplary lamp assembly 212. The lamp assembly 212 is similar to the lamp assemblies 12, 112 discussed above. However, in this embodiment, a pair of light blocking components 248 are arranged between a housing 214 and a bezel 220 of the lamp assembly 212. In an embodiment, the light blocking components 248 may be attached to the housing 214 in the same manner as the bezels discussed above.

Each light blocking component 248 may include a pocket 250 shaped to receive and cover a portion of a light bar 216 that is arranged within the housing 214. The light blocking components 248 may be vertically aligned with the light bar 216.

Each light blocking component 248 may be configured to block at least some of the light emitted from the light bar 216 to provide more than one light section. In this embodiment, the light blocking components 248 may be made of an opaque material and may be spaced apart relative to one another to divide the light bar 216 into three distinct light sections. Light from the light bar 216 may be emitted through the areas adjacent the light blocking components 248 (i.e., the portions of the light bar 216 that are uncovered by the light blocking components 248). In this embodiment, in a similar manner to the embodiment shown in FIG. 3, a first light section 244A is provided on one side (i.e., the left side) of a first light blocking component 248A, a second light section 244B is provided between the first light blocking component 248A and a second light blocking component 248B, and a third light section 244C is provided to one side (i.e., the right side) of the second light blocking component 248B. With the light blocking components 248 dividing the light bar 216 into three separate light sections, the lamp assembly 212 may function as a rear ID lamp.

The size and placement of the light sections can be adjusted by changing the spacing between the light blocking components 248. In an embodiment, the center-to-center spacing between each of the light sections is at least 6 inches (or 15.24 centimeters)—that is, the distance from the center of one light section to the center of an adjacent light section measures at least 6 inches along the horizontal axis.

The bezel 220 may be attached to the housing 214 over the light blocking components 248 to at least partially enclose the light bar 216 within the housing 214. In an embodiment, the light blocking components 248 are positioned between the housing 214 and the bezel 220. The bezel 220 may include an elongated opening 246 that extends over each of the light blocking components 248. The elongated opening 246 may be vertically aligned with the light bar 216 and may establish one or more areas where the light bar 216 and the light blocking components 248 are not covered by the opaque material of the bezel 220. A lens component 222 may be disposed outwardly of the bezel 220. The bezel 220 may be made of an opaque material that allows light transmitted through the bezel 220 to also be transmitted through the lens component 222.

In an embodiment, the bezel 220 and the lens component 222 may be formed together as a single integrated component using the two-shot technique discussed above.

In an alternative embodiment, the bezel 220 can be used without the light blocking components 248. In such an embodiment, the elongated opening 246 of the bezel 220 allows more light from the light bar 216 to be transmitted through it as a single uninterrupted light section such that that the lamp assembly 212 can function as a CHMSL.

The lamp assemblies of this disclosure provide adaptable lamp assemblies that can be used as either center high-mounted stop lamp (CHMSL) assemblies or rear identification (rear ID) lamp assemblies. Among the other benefits, the lamp assemblies are designed with at least one bezel or at least one light blocking component configured to block at least some of the light emitted from a light bar to provide multiple light sections.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A vehicle exterior lighting system, comprising:
an adaptable lamp assembly including:
a housing,
a light bar arranged within the housing and configured to emit light, and
a bezel or a light blocking component arranged adjacent to the light bar and configured to block at least a portion of the light emitted from the light bar to provide more than one light section within the adaptable lamp assembly.

2. The vehicle exterior lighting system as recited in claim 1, wherein the bezel includes a plurality of openings to allow the light from the light bar to be transmitted through the bezel, wherein the plurality of openings includes a first opening, a second opening, and a third opening, and wherein a first portion of the light transmitted through the first opening provides a first light section of the adaptable lamp assembly, a second portion of the light transmitted through the second opening provides a second light section of the adaptable lamp assembly, and a third portion of the light transmitted through the third opening provides a third light section of the adaptable lamp assembly.

3. (canceled)

4. The vehicle exterior lighting system as recited in claim 2, further comprising a first lens component disposed outwardly of the bezel, wherein the bezel is opaque and the first lens component is transparent.

5. The vehicle exterior lighting system as recited in claim 4, wherein the bezel is a first bezel that provides a first type of identification lamp of the adaptable lamp assembly, and further comprising a second bezel configured to replace the first bezel to provide a second type of identification lamp of the adaptable lamp assembly.

6. The vehicle exterior lighting system as recited in claim 5, wherein an elongated opening of the second bezel is aligned with the light bar.

7. The vehicle exterior lighting system as recited in claim 5, further comprising a second lens component disposed outwardly of the second bezel, wherein the second bezel is opaque and the second lens component is transparent.

8. (canceled)

9. A vehicle exterior lighting system, comprising:
an adaptable lamp assembly including:
a housing,
a light bar arranged within the housing and configured to emit light, and
a bezel or a light blocking component arranged adjacent to the light bar and configured to block at least a portion of the light emitted from the light bar to provide more than one light section within the adaptable lamp assembly,
wherein the light blocking component is a first light blocking component, and further comprising a second light blocking component arranged adjacent to the light bar and configured to block at least another portion of the light emitted from the light bar, the first light blocking component and the second light blocking component each include a pocket configured to receive and cover a portion of the light bar.

10. The vehicle exterior lighting system as recited in claim 9, wherein the first light blocking component and the second light blocking component are spaced apart to divide the light bar into a first light section, a second light section, and a third light section.

11. The vehicle exterior lighting system as recited in claim 10, further comprising an outer bezel attached to the housing over the first light blocking component and the second light blocking component, and wherein the first light blocking component and the second light blocking component are positioned between the housing and the outer bezel, further comprising a lens component disposed outwardly of the outer bezel, wherein the first light blocking component, the second light blocking component, and the outer bezel are opaque, and the lens component is transparent.

12. (canceled)

13. (canceled)

14. The vehicle exterior lighting system as recited in claim 1, wherein the adaptable lamp assembly is a rear identification lamp.

15. The vehicle exterior lighting system as recited in claim 14, wherein the bezel or the light blocking component is a removable component of the adaptable lamp assembly to convert the rear identification lamp into a center high-mounted stop lamp.

16. A vehicle lamp assembly method, comprising:
arranging a bezel or a light blocking component adjacent to a light bar within a housing of an adaptable lamp assembly to configure the adaptable lamp assembly as a first type of identification lamp for a motor vehicle,
wherein the bezel or light blocking component blocks at least a portion of the light emitted from the light bar.

17. The vehicle lamp assembly method as recited in claim 16, wherein the bezel includes a first opening, a second opening, and a third opening, and wherein the first type of identification lamp transmits light through the first opening, the second opening, and the third opening to provide a first light section, a second light section, and third light section.

18. The vehicle lamp assembly method as recited in claim 16, wherein the light blocking component is a first light blocking component, and further comprising a second light blocking component configured to block at least a portion of the light emitted from the light bar.

19. The vehicle lamp assembly method as recited in claim 16, wherein the first type of identification lamp is a rear identification lamp.

20. The vehicle lamp assembly method as recited in claim 19, further comprising removing the bezel or the light blocking component to convert the rear identification lamp to a center high-mounted stop lamp.

21. The vehicle exterior lighting system as recited in claim 1, wherein the light bar is a continuous elongated light bar and emits light along a longitudinal axis.

22. The vehicle exterior lighting system as recited in claim 1, wherein the light bar includes a first end portion and an opposite second end portion, and a printed circuit board is connected to a respective one of the first and second end portions, wherein each printed circuit board supports a plurality of light emitting diodes configured to emit light into the light bar.

23. The vehicle lamp assembly method as recited in claim 16, wherein the light bar is a continuous elongated light bar and emits light along a longitudinal axis.

24. The vehicle lamp assembly method as recited in claim 16, wherein the light bar includes a first end portion and an opposite second end portion, and a printed circuit board is connected to a respective one of the first and second end portions, wherein each printed circuit board supports a plurality of light emitting diodes configured to emit light into the light bar.
